(19) United States
(12) Patent Application Publication
(10) Pub. No.: US 2024/0224187 A1
(43) Pub. Date: Jul. 4, 2024

(54) THERMAL MITIGATION FOR CELLULAR DEVICES

(71) Applicant: GOOGLE LLC, Mountain View, CA (US)

(72) Inventors: Madhusudan Kinthada Venkata, San Diego, CA (US); Shivank Nayak, Milpitas, CA (US); Siddharth Ray, Sunnyvale, CA (US)

(21) Appl. No.: 18/557,455

(22) PCT Filed: May 6, 2021
(86) PCT No.: PCT/US2021/031043

§ 371 Date: Oct. 26, 2023

(51) Int. Cl. H04W 52/02; G06F 1/3234

(52) U.S. Cl. CPC H04W 52/0251; G06F 1/3278

(57) ABSTRACT

A cellular user equipment (UE) device is configured to determine a thermal trigger event has occurred. Responsive to the thermal trigger event, the UE device determines a first data measurement associated with at least a first radio access technology (RAT) of the UE device and a second data measurement associated with at least a second RAT of the UE device. The UE device performs a first level of thermal mitigation for the first RAT and a second level of thermal mitigation for the second RAT based on the first data measurement being different than the second data measurement.

### BACKGROUND

The evolution of wireless communication to fifth-generation (5G) standards and technologies provides higher data rates and greater capacity, with improved reliability and lower latency that enhances mobile broadband services. 5G technologies also provide new classes of services for vehicular networking, fixed wireless broadband, and the Internet of Things (IOT).

5G networks enable higher data-transfer rates than existing networks, such as fourth-generation (4G) networks. These higher data rates may cause the user equipment (UE) device to operate at higher temperatures and consume more power relative to conventional networks. The increased operating temperatures may thermally limit the performance of the UE device. For example, 5G throughput performance may be degraded, or if the UE device is able to access multiple radio access technologies (RAT), such as 4G and 5G RATs, 4G throughput may also be degraded. In addition, increased operating temperatures can damage one or more physical components of the UE device or cause discomfort to a user of the UE device.

### SUMMARY OF EMBODIMENTS

In accordance with one aspect, a method at a cellular user equipment (UE) device includes determining, responsive to a thermal trigger event having occurred, a first data measurement associated with at least a first radio access technology (RAT) of the UE device and a second data measurement associated with at least a second RAT of the UE device. The UE device performs a first level of thermal mitigation for the first RAT and a second level of thermal mitigation for the second RAT based on the first data measurement being different than the second data measurement.

In at least some embodiments, determining that the thermal trigger event has occurred includes determining that one or more thermal parameters associated with the UE device satisfy at least one thermal threshold. The at least one thermal threshold, in at least one embodiments, is a predetermined threshold.

In at least some embodiments, the first data measurement is a first data throughput determined based on monitoring an aggregated data throughput across multiple downlink component carriers associated with the first RAT. The second data measurement is a second data throughput determined based on monitoring an aggregated throughput rate across multiple downlink component carriers associated with the second RAT.

In at least some embodiments, the first data measurement is a first amount of data scheduled for a first portion of a Split-Bearer configured for the first RAT, and the second data measurement is a second amount of data scheduled for a second portion of the Split-Bearer configured for the second RAT.

In at least some embodiments, the first data measurement is lower than the second data measurement.

In at least some embodiments, the first data measurement is higher than the second data measurement.

In at least some embodiments, responsive to performing the first level of thermal mitigation and the second level of thermal mitigation, the UE device determines if the thermal trigger event has ended. Responsive to the thermal trigger event having ended, the UE device halts the first level of thermal mitigation and the second level of thermal mitigation. Responsive to the thermal trigger event still occurring, the UE device increases at least one of the first level of thermal mitigation or the second level of thermal mitigation to a more aggressive level of thermal mitigation.

In at least some embodiments, the UE device selects the first level of thermal mitigation based on the first level of thermal mitigation being a relaxed level of thermal mitigation. The UE device selects the second level of thermal mitigation based on the second level of thermal mitigation being an aggressive level of thermal mitigation. The relaxed level of thermal mitigation reduces the temperature of the UE device more gradually than the aggressive level of thermal mitigation and has a less negative impact on data throughput than the aggressive level of thermal mitigation. In at least some embodiments, the UE device further selects the first level of thermal mitigation based on the first data measurement being lower than the second data measurement, and the UE device further selects the second level of thermal mitigation based on the second data measurement being higher than the first data measurement.

In at least some embodiments, the UE device selects the first level of thermal mitigation based on the first level of thermal mitigation being an aggressive level of thermal mitigation. The UE device selects the second level of thermal mitigation based on the second level of thermal mitigation being a relaxed level of thermal mitigation. The aggressive level of thermal mitigation reduces a temperature of the UE device faster than the relaxed level of thermal mitigation and has an increased negative impact on data throughput than the relaxed level of thermal mitigation. In at least some embodiments, the UE device further selects the first level of thermal mitigation based on the first data measurement being higher than the second data measurement, and the UE device further selects the second level of thermal mitigation based on the second data measurement being lower than the first data measurement.

In at least some embodiments, the first RAT is a Third Generation Partnership Project (3GPP) Long-Term Evolution (LTE) Fourth-Generation (4G) RAT and the second RAT is a 3GPP Fifth-Generation (5G) New Radio (NR) RAT, or vice versa.

In accordance with another aspect, a method at a cellular user equipment (UE) device includes determining, responsive to a thermal trigger even having occurred, a data measurement associated with each of a plurality of secondary cells associated with at least one radio access technology (RAT) of the UE device. The UE device selects a level of thermal mitigation for the at least one RAT based on the data measurement and performs the selected level of thermal mitigation.

In at least some embodiments, the UE device determines a thermal mitigation priority for each of the plurality of secondary cells based on their associated data measurement.

In at least some embodiments, performing the selected level of thermal mitigation includes selecting at least one secondary cell from the plurality of secondary cells based on the thermal mitigation priority determined for the at least one secondary cell, and dropping the selected secondary cell.

In accordance with a further aspect, a method at a cellular user equipment (UE) device within a cellular network includes determining that a thermal trigger event has occurred. Responsive to the thermal trigger event, the UE device informs the cellular network of reduced bandwidth part capabilities at the UE device. The UE device receives a reduced bandwidth part configuration from the cellular network and implements the reduced bandwidth part configuration.

In at least some embodiments, the UE device determines that the thermal trigger event has ended. Responsive to the thermal trigger event having ended, the UE device informs the cellular network of increased bandwidth part capabilities at the UE device. The UE device receives an increased bandwidth part configuration from the cellular network and implements the increased bandwidth part configuration.

In accordance with yet another aspect, a method at a cellular user equipment (UE) device within a cellular network includes determining, responsive to a thermal trigger even having occurred, a current channel quality indicator for a connection with the cellular network. The UE selects a lower channel quality indicator based on the current channel quality indicator and sends the lower channel quality indicator to the cellular network.

In at least some embodiments, the UE device determines that the thermal trigger event has ended. Responsive to the thermal trigger event having ended, the UE device determines a new current channel quality indicator for the connection with the cellular network. The UE device sends the new current channel quality indicator to the cellular network.

In accordance with a further aspect, a user equipment device includes one or more radio frequency (RF) modems configured to wirelessly communicate with at least one network. The user equipment device further includes one or more processors coupled to the one or more RF modems, and at least one memory storing executable instructions. The executable instructions are configured to manipulate at least one of the one or more processors or the one or more RF modems to perform any of the methods described herein.

In accordance with a further aspect, there is provided a computer program product comprising a set of instructions which, when executed on an apparatus, is configured to cause the apparatus to carry out the method of any preceding method definition.

In accordance with another aspect, there is be provided a non-transitory computer readable medium comprising program instructions stored thereon for performing a method of any preceding method definition.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating an example wireless communication system employing a user equipment (UE) device implementing one or more thermal mitigation mechanisms in accordance with some embodiments.

FIG. 2 is a block diagram illustrating example modes of a thermal mitigation mechanism employed by the UE device of FIG. 1 in accordance with some embodiments.

FIG. 3 is a diagram illustrating an example configuration of a UE device implementing one or more thermal mitigation mechanisms in accordance with some embodiments.

FIG. 4 is a diagram illustrating an example operation of implementing thermal mitigation at a UE device based on the data rate scheduled for each radio access technology (RAT) of the UE device in accordance with some embodiments.

FIG. 5 is a diagram illustrating an example operation of implementing thermal mitigation at a UE device based on the temperature or amount of heat generated by each RAT of the UE device in accordance with some embodiments.

FIG. 6 is a diagram illustrating an example operation of implementing thermal mitigation at a UE device based on aggregated download throughput strategy in a non-standalone network architecture in accordance with some embodiments.

FIG. 7 is a diagram illustrating an example operation of implementing thermal mitigation at a UE device based on secondary cell throughput in accordance with some embodiments.

FIG. 8 is a diagram illustrating an example operation of implementing thermal mitigation at a UE device based on bandwidth parts in accordance with some embodiments.

FIG. 9 is a diagram illustrating an example operation of implementing thermal mitigation at a UE device based on channel quality indicators in accordance with some embodiments.

FIG. 10 is a chart illustrating examples of different levels of thermal mitigation and associated mitigation actions in accordance with some embodiments.

### DETAILED DESCRIPTION

Thermal mitigation performed by a multi-mode UE device typically includes static techniques performed on each radio access technology (RAT) independent of each other. In many instances, these static techniques provide inefficient thermal mitigation since they do not typically consider which of the RATs generate the most heat. Also, the static techniques may apply more aggressive mitigation to a RAT when relaxed mitigation is sufficient, which unnecessarily reduces the performance of the UE device.

The following describes embodiments of systems and methods for implementing UE thermal mitigation techniques that consider factors, such as the throughput/data rate associated with each RAT of the UE device, and perform multi-level and dynamic mitigation actions. For example, in at least some embodiments, a UE device is configured with a first thermal mitigation technique that considers the throughput/data rate of each RAT. In other examples, the first thermal mitigation technique considers the ratio of data scheduled on a Split-Bearer between the different RATs. In further examples, the first thermal mitigation technique considers the throughput of secondary cells allocated/assigned to the different RATs of the UE device. The UE device selects a first level of thermal mitigation for the RAT associated with a higher throughput/data rate and selects a second level of thermal mitigation for the RAT associated with a lower throughput/data rate. The first thermal mitigation technique is dynamic, thereby allowing different thermal mitigation levels and actions to be selected/performed based on measured throughput over a period of time. As such, more efficient thermal mitigation is achieved while maintaining a given level of performance/throughput at the UE device. In at least some embodiments, “throughput”, as used herein, refers to the number of bits received per second and is used interchangeably with “data rate”.

The UE device, in at least some embodiments, is configured with a second thermal mitigation technique that considers bandwidth parts configured for the UE device. When the UE device determines that thermal mitigation is to be performed, the UE device informs the network that it has reduced bandwidth part capabilities. In response, the network instructs the UE device to only use an initial or default bandwidth part. Therefore, the UE device only monitors a subset of the carrier bandwidth parts instead of all the bandwidth parts, which results in the UE device cooling down faster and allows the UE device to maintain its connection with the network.

The UE device, in at least some embodiments, is configured with a third thermal mitigation technique that is based on a Channel Quality Indicator (CQI). When implementing the third thermal mitigation technique, the UE device performs data rate scaling by lowering the reported CQI in a step-wise manner. Lowering the CQI results in a lower Modulation and Coding Scheme (MCS), which reduces the temperature of the UE device. When thermal mitigation is no longer needed, the UE device scales up the data rate by reporting the actual CQI to the network.

As such, the techniques described herein provide for a UE device to implement one or more dynamic thermal mitigation techniques that, in at least some embodiments, take into consideration one or more various factors when determining the level of thermal mitigation and the mitigation actions to be performed for a given RAT. The selection of a RAT, level of thermal mitigation, and mitigation actions can be dynamically changed based on measured throughput over a period of time.

For ease of illustration, the following techniques are described in an example context in which one or more UE devices and Radio Access Networks (RANs) implement one or more radio access technologies (RATs), including at least a Fifth Generation (5G) New Radio (NR) standard (e.g., Third Generation Partnership Project (3GPP) Release 15, 3GPP Release 16, etc.) (hereinafter, “5G NR” or “5G NR standard”). However, it should be understood that the present disclosure is not limited to networks employing a 5G NR RAT configuration, but rather the techniques described herein can be applied to any combination of different RATs employed at the UE devices and the RANs. It should also be understood that the present disclosure is not limited to any specific network configurations or architectures described herein for implementing thermal mitigation at the UE, but instead, techniques described herein can be applied to any configuration of RANs. Also, the present disclosure is not limited to the examples and context described herein, but rather the techniques described herein can be applied to any network environment where a UE device implements thermal mitigation techniques.

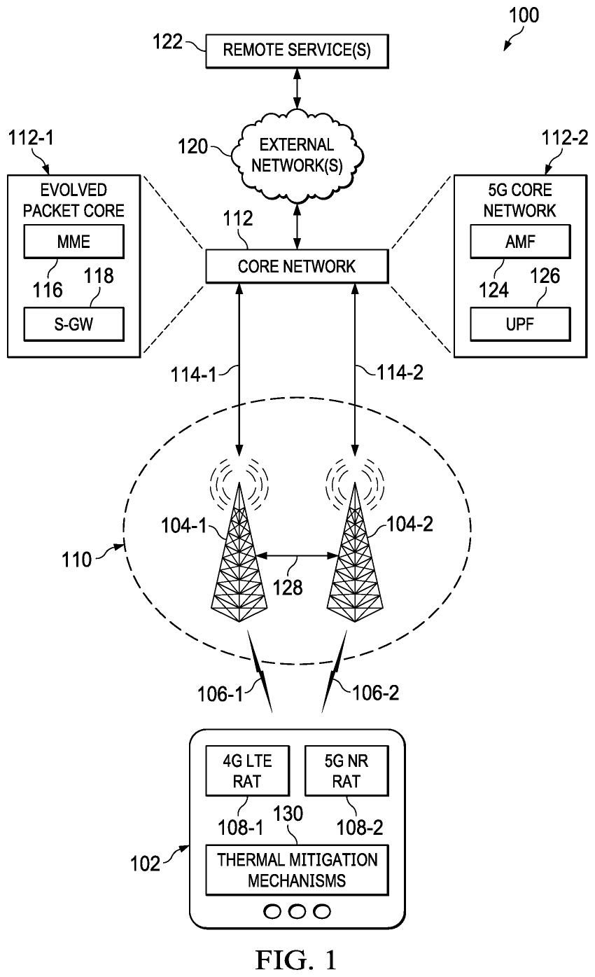

FIG. 1 illustrates a mobile cellular system (network) 100 in accordance with at least some embodiments. As shown, the mobile cellular system 100 includes a user equipment (UE) device 102 that is configured to communicate with one or more base stations 104 (illustrated as base stations 104-1 and 104-2) through one or more wireless communication links 106 (illustrated as wireless links 106-1 and 106-2). The UE device 102, in at least some embodiments, includes any of a variety of wireless communication devices, such as a cellular phone, a cellular-enabled tablet computer or cellular-enabled notebook computer, a cellular-enabled wearable device, an automobile, or other vehicle employing cellular services (e.g., for navigation, provision of entertainment services, in-vehicle mobile hotspots, etc.), and so on. In at least some embodiments, the UE device 102 employs a single radio access technology (RAT) 108. In other embodiments, the UE device 102 is a multi-mode UE device that employs multiple RATs 108. Examples of multiple RATs include a 3GPP Long-Term Evolution (3GPP LTE) RAT 108-1 and a 3GPP Fifth Generation New Radio (5G NR) RAT 108-2.

In at least some embodiments, the base stations 104 are implemented in a macrocell, microcell, small cell, picocell, and the like, or any combination thereof. Examples of base stations 104 include an Evolved Universal Terrestrial Radio Access Network Node B (E-UTRAN Node B), evolved Node B, eNodeB (eNB), Next Generation Node B, (gNode B or gNB) and so on. The base stations 104 communicate with the UE device 102 via the wireless links 106, which are implemented using any suitable type of wireless link. The wireless links 106, in at least some embodiments, include a downlink of data and control information communicated from the base stations 104 to the UE device 102, an uplink of data and control information communicated from the UE device 102 to the base stations 104, or both. The wireless links 106 (or bearers), in at least some embodiments, are implemented using any suitable communication protocol or standard, or combination of communication protocols or standards, such as 3GPP 4G LTE, 5G NR, and so on. In at least some embodiments, multiple wireless links 106 are aggregated in a carrier aggregation to provide a higher data rate for the UE device 102. Also, multiple wireless links 106 from multiple base stations 104 are configured, in at least some embodiments, for Coordinated Multipoint (COMP) communication with the UE device 102, as well as dual connectivity, such as single-RAT LTE-LTE or NR-NR dual connectivity, or Multi-Radio Access Technology (Multi-RAT) Dual Connectivity (MR-DC) including E-UTRA-NR Dual Connectivity (EN-DC), Next Generation (NG) Radio Access Network (RAN) E-UTRA-NR Dual Connectivity (NGEN-DC, and NR E-UTRA Dual connectivity (NE-DC).

The base stations 104 collectively form a Radio Access Network 110, such as an E-UTRAN or 5G NR RAN. The base stations 104 are connected to a core network 112 via control-plane and user-plane interfaces through one or more links 114 (illustrated as links 114-1 and 114-2). Depending on the configuration of the mobile cellular system 100, the core network 112 is either an Evolved Packet Core (EPC) network 112-1 or a 5G Core Network (5GC) 110-2. For example, in an E-UTRAN configuration or a 5G non-standalone (NSA) EN-DC configuration, the core network 112 is an EPC network 112-1 that includes, for example, a Mobility Management Entity (MME) 116 and a Serving Gateway (S-GW) 118. The MME 116 provides control-plane functions, such as registration and authentication of multiple UE devices 102, authorization, mobility management, and so on. The S-GW 118 relays user-plane data between UE devices102 and external networks 120 (e.g., the Internet) and one or more remote services 122. In a 5G standalone (SA) configuration or an NSA NE-DC or NGEN-DC configuration, the core network 112 is a 5GC network 112-2. The 5GC 112-2 includes, for example, an Access and Mobility Management Function (AMF) 124 and a User Plane Function (UPF) 126. The AMF 124 provides control-plane functions such as registration and authentication of multiple UEs 102, authorization, mobility management, and so on. The UPF 126 relays user-plane data between UEs 102 and external networks 120 (e.g., the Internet) and one or more remote services 122.

In at least some embodiments, when the UE device 102 uses EN-DC, the UE device 102 communicates with a first base station 104-1 implementing, for example, a 4G LTE RAT, which acts as a Master Node (MN), and the wireless link 106-1 is an E-UTRA link. The UE device 102 also communicates with a second base station 104-2 implementing, for example, a 5G NR RAT, which acts as a Secondary Node (SN), and the wireless link 106-2 is a 5G NR link. At link 128, the first base station (e.g., eNB) 104-1 and the second base station (e.g., 5G NR) 104-2 communicate user-plane and control-plane data via, for example, an X2 interface. The first base station 104-1 communicates control plane information with the MME 116 in the EPC 112-1 via, for example, an S1-MME interface and relays control-plane information to the second base station 104-2 via, for example, the X2 interface.

User Plane (UP) data is transported between the EPC network 112-1 and the UE device 102 using Data Radio Bearers (DRBs). Examples of DRBs in EN-DC include a Master Cell Group (MCG) Bearer, a Secondary Cell Group (SCG) Bearer, and a Split-Bearer. An MCG Bearer is a direct DRB that terminates at the MN (e.g., the first base station 104-1) and only uses the MN lower layers (Radio Link Control (RLC), Medium Access Layer (MAC), and Physical Layer (PHY)). When an MCG Bearer is used, the MN receives data from the EPC network 112-1 and transmits the data to the UE device 102. An SCG Bearer is a direct DRB that terminates at the SN (e.g., the second base station 104-2) and only uses the SN lower layers (RLC, MAC, and PHY).

When an SCG bearer is used, the SN receives data from the EPC network 112-1 and transmits the data to the UE device 102. A Split-Bearer is either an MCG Split-Bearer or an SCG Split-Bearer. An MCG Split-Bearer is a DRB that terminates at the MCG and uses either or both of the MN and SN lower layers. When an MCG Split-Bearer is used, the MN receives data from the EPC network 112-1 and splits the data into two parts. One part of the data is transmitted from the MN to the UE device 102, and the second part of the data is transmitted from the SN to the UE device 102. An SCG Split-Bearer is a DRB that terminates at the SN and uses either or both of the MN and SN lower layers. When an SCG Split-Bearer is used, the SN receives data from the EPC network 112-1 and splits the data into two parts. One part of the data is transmitted from the SN to the UE device 102, and the second part of the data is transmitted from the MN to the UE device 102.

In other embodiments, when the UE device 102 uses NGEN-DC, the UE device 102 communicates with the first base station 104-1, which acts as the Master Node (MN), and the wireless link 106-1 is an E-UTRA link. The UE device 102 also communicates with the second base station 104-2, which acts as a Secondary Node 20) (SN), and the wireless link 106-2 is a 5G NR link. At link 128, the first base station 104-1 and the second base station 104-2 communicate user-plane and control-plane data via, for example, an Xn interface. The first base station 104-1 communicates control plane information with the AMF 124 in the 5GC network 112-2 via, for example, an NG-C interface and relays control-plane information to the second base station 104-2 via, for example, the Xn interface.

In further embodiments, when the UE device 102 uses NE-DC, the UE device 102 communicates with the second base station 104-2, which acts as the Master Node (MN), and the wireless link 106-1 is a 5G NR link. The UE device 102 also communicates with the first base station 104-1, which acts as a Secondary Node (SN), and the wireless link 106-1 is an E-UTRA link. At link 128, the first base station 104-1 and the second base station 104-2 communicate user-plane and control-plane data via, for example, the Xn interface. The second base station 104-2 communicates control plane information with the AMF 124 in the 5GC network 112-2 via, for example, the NG-C interface and relays control-plane information to the first base station 104-1 via, for example, the Xn interface.

Turning from an MR-DC configuration, the FIG. 1 environment, in at least some embodiments, represents a single-RAT DC configuration. In one type of single-RAT DC situation, both base stations 104-1 and 104-2 are E-UTRA base stations and communicate user-plane and control-plane data via, for example, an X2 interface over link 128, and both base stations 104-1 and 104-2 link to the EPC 112-1. In another type of single-RAT DC configuration, both base stations 104-1 and 104-2 are 5G NR base stations and communicate user-plane and control-plane data via, for example, an Xn interface over link 128, and both base stations 104-1 and 104-2 link to the 5GC network 112-2.

During operation, the UE device 102 may experience elevated operating temperatures (thermals) depending on one or more of its data rate, clock speed, the number of RATs currently operating, and so on. Elevated operating temperatures may, for example, overheat components of the UE device 102, reduce device performance and throughput, or cause user discomfort. Accordingly, in at least some embodiments, the UE device 102 employs one or more thermal mitigation mechanisms 130 to efficiently and effectively manage the thermal state of the UE device 102. As described in greater detail below, the thermal mitigation mechanism(s) 130 includes one or more modes that perform multi-level and dynamic thermal mitigation operations. These thermal mitigation operations consider factors such as aggregated downlink (DL) throughput/data rate, sources of heat, or a combination thereof to select one or more the RATs 108 and determine the thermal mitigation actions to perform thereon. The multi-level and dynamic nature of the thermal mitigation mechanism(s) 130 allows the UE device 102 to maintain an active connection with the network 100 while reducing the temperature of one or more of its components. Also, the thermal mitigation mechanism(s) 130 provides for increased performance of the UE device 102 during thermal mitigation compared to more static thermal mitigation mechanisms that apply a predetermined and independent level of mitigation to the 4G LTE RATs and 5G NR RATs.

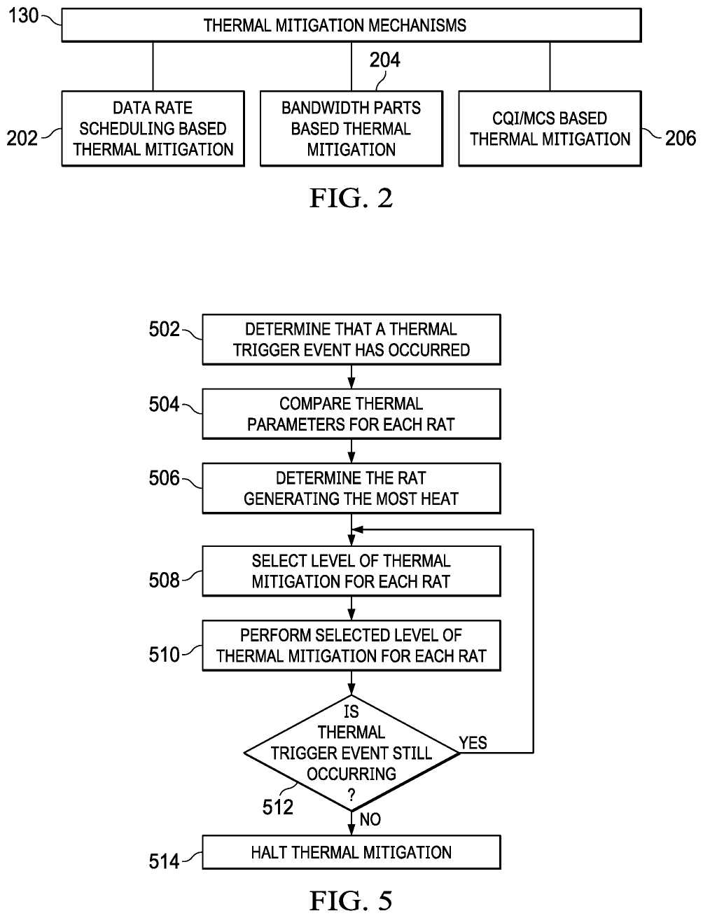

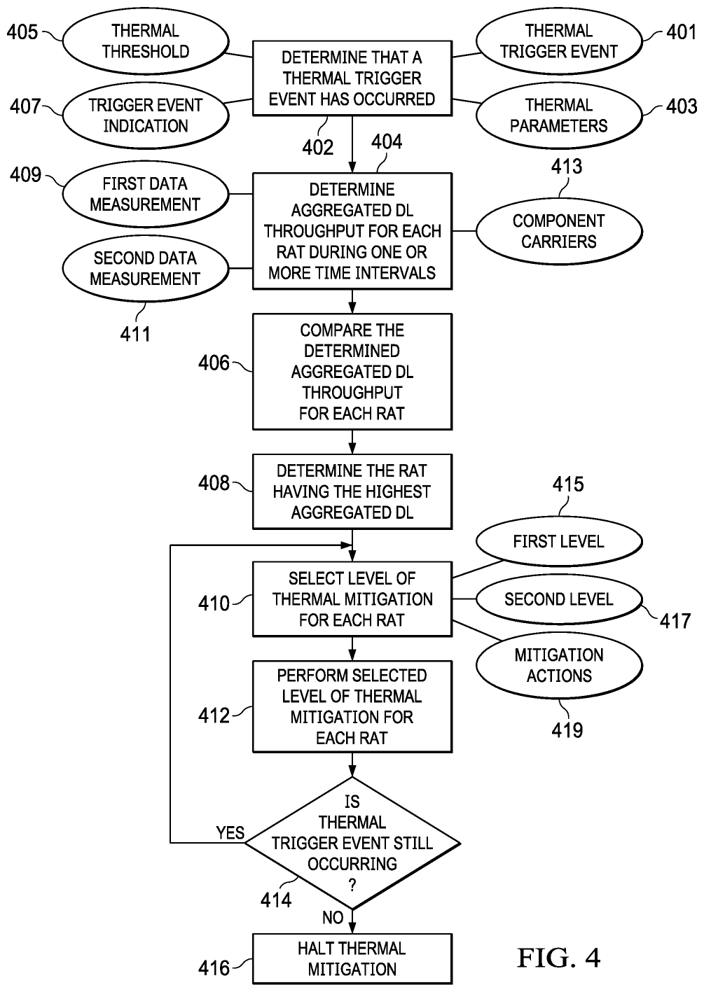

FIG. 2 illustrates various example modes employed singularly or in various combinations by the UE device 102 as part of the thermal mitigation mechanism 130 in accordance with some embodiments. Each of these modes is discussed in greater detail below with respect to FIG. 4 to FIG. 9. One such mode includes a first thermal mitigation mode 202, in which thermal mitigation is performed based on data rate scheduling in a non-standalone network (NSA) architecture. In this mode, different levels of thermal mitigation are performed on the 4G LTE RAT 108-1 and 5G NR RAT 108-2 based on their throughputs/data rates. Another mode includes a second thermal mitigation mode 204, in which thermal mitigation is performed based on bandwidth parts (BWP). In this mode, different levels of thermal mitigation are performed by adjusting the BWP capabilities of the UE device 102. Yet another mode includes a third thermal mitigation mode 206, in which thermal mitigation is performed based on the channel quality indicator (CQI) and modulation and coding scheme (MCS) of the UE device 102. In this mode, different levels of thermal mitigation are performed by adjusting the CQI of the UE device 102 in a step-wise fashion.

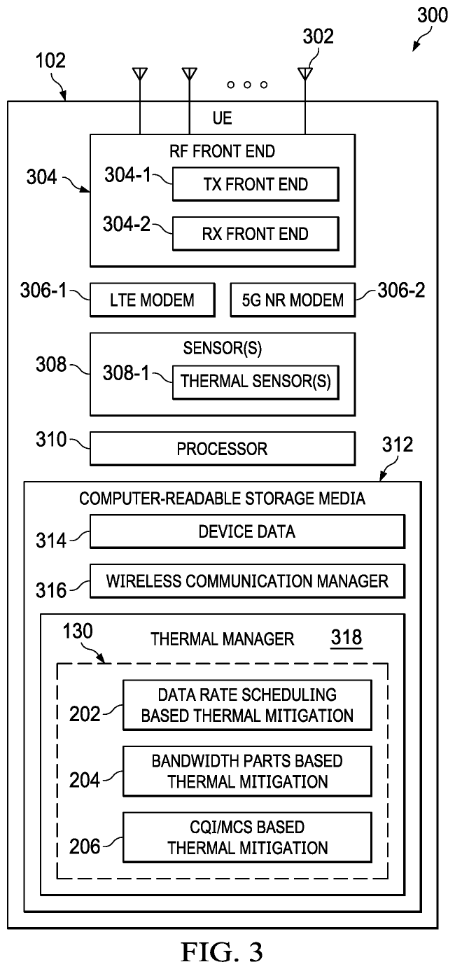

FIG. 3 illustrates an example device diagram 300 of a UE device 102. In aspects, the device diagram 300 describes a UE device that can implement various aspects of thermal mitigation. The UE device 102 may include additional functions and interfaces that are omitted from FIG. 3 for the sake of clarity. The UE device 102, in at least some embodiments, includes antennas 302, a radio frequency (RF) front end 304, and one or more RF transceivers 306 (e.g., a 3GPP 4G LTE transceiver 306-1 and a 5G NR transceiver 306-2) for communicating with one or more base stations 104 in a RAN 110, such as a 5G RAN, an E-UTRAN, a combination thereof, and so on. The RF front end 304, in at least some embodiments, includes a transmitting (Tx) front end 304-1 and a receiving (Rx) front end 304-2. The Tx front end 304-1 includes components such as one or more power amplifiers (PA), drivers, mixers, filters, and so on. The Rx front end 304-2 includes components such as low-noise amplifiers (LNAs), mixers, filters, and so on. The RF front end 304, in at least some embodiments, couples or connects the one or more transceivers 306, such as the LTE transceiver 306-1 and the 5G NR transceiver 306-2, to the antennas 302 to facilitate various types of wireless communication.

In at least some embodiments, the antennas 302 of the UE device 102 include an array of multiple antennas configured similar to or different from each other. The antennas 302 and the RF front end 304, in at least some embodiments, are tuned to or are tunable to one or more frequency bands, such as those defined by the 3GPP LTE, 3GPP 5G NR, IEEE Wireless Local Area Network (WLAN), IEEE Wireless Metropolitan Area Network (WMAN), or other communication standards. In at least some embodiments, the antennas 302, the RF front end 304, the LTE transceiver 306-1, and the 5G NR transceiver 306-2 are configured to support beamforming (e.g., analog, digital, or hybrid) or in-phase and quadrature (I/Q) operations (e.g., I/Q modulation or demodulation operations) for the transmission and reception of communications with one or more base stations 104. By way of example, the antennas 302 and the RF front end 304 operate in sub-gigahertz bands, sub-6 GHz bands, above 6 GHz bands, or a combination of these bands defined by the 3GPP LTE, 3GPP 5G NR, or other communication standards.

In at least some embodiments, the antennas 302 include one or more receiving antennas positioned in a one-dimensional shape (e.g., a line) or a two-dimensional shape (e.g., a triangle, a rectangle, or an L-shape) for implementations that include three or more receiving antenna elements. While the one-dimensional shape enables the measurement of one angular dimension (e.g., an azimuth or an elevation), the two-dimensional shape enables two angular dimensions to be measured (e.g., both azimuth and elevation). Using at least a portion of the antennas 302, the UE device 102 can form beams that are steered or un-steered, wide or narrow, or shaped (e.g., as a hemisphere, cube, fan, cone, or cylinder). The one or more transmitting antennas may have an un-steered omnidirectional radiation pattern or may be able to produce a wide steerable beam. Either of these techniques enables the UE device 102 to transmit a radar signal to illuminate a large volume of space. In some embodiments, the receiving antennas generate thousands of narrow steered beams (e.g., 2000 beams, 4000 beams, or 6000 beams) with digital beamforming to achieve desired levels of angular accuracy and angular resolution.

The UE device 102, in at least some embodiments, includes one or more sensors 308 implemented to detect various properties such as one or more of temperature, supplied power, power usage, battery state, or the like. One example of the sensor(s) is a thermal sensor 308-1 that can include any one or a combination of temperature/thermal sensors, thermistors, or heat sensors. The thermal sensor(s) 308-1, in at least some embodiments, is configured to measure temperature and other thermal properties of the UE device 102, including individual measurements of various components of the UE device 102, the external environment of the UE device 102, and so on. Other examples of the sensor(s) 308 include any one or a combination of battery sensors, power usage sensors, and so on.

The UE device 102 also includes at least one processor 310 and a non-transitory computer-readable storage media 312 (CRM 312). The processor 310, in at least some embodiments, is a single-core processor or a multiple-core processor composed of a variety of materials, such as silicon, polysilicon, high-K dielectric, copper, and so on. The computer-readable storage media described herein excludes propagating signals. The CRM 312, in at least some embodiments, includes any suitable memory or storage device such as random-access memory (RAM), static RAM (SRAM), dynamic RAM (DRAM), non-volatile RAM (NVRAM), read-only memory (ROM), or Flash memory useable to store device data 314 of the UE device 102. The device data 314 includes, for example, user data, multimedia data, beamforming codebooks, applications, an operating system of the UE device 102, or a combination thereof, which are executable by the processor 310 to enable user-plane communication, control-plane signaling, and user interaction with the UE device 102.

The CRM 312, in at least some embodiments, also includes either or both of a communication manager 316 and a thermal manager 318. Alternatively, or additionally, either or both of the communication manager 316 and thermal manager 318, in at least some embodiments, is implemented in whole or part as hardware logic or circuitry integrated with or separate from other components of the UE device 102. In at least some embodiments, the communication manager 316 configures the RF front end 304, the LTE transceiver (modem) 306-1, the 5G NR transceiver (modem) 306-2, or a combination thereof, to perform one or more wireless communication operations.

The thermal manager 318, in at least some embodiments, monitors the thermal state of one or more components of the UE device 102, such as the processor 310, the Tx front end 304-1, the Rx front end 304-2, the LTE transceiver 306-1, the 5G NR transceiver 306-2, and so on. For example, in at least some embodiments, the thermal manager 318 communicates with one or more of the thermal sensors 308-1 in or coupled to the user equipment 102. The thermal manager 318, in at least some embodiments, stores and/or transmits values of the measurements to other components of the user equipment 102 or other devices. In other embodiments, a different component of the UE device 102 monitors the thermal state of one or more components of the UE device 102 and communicates with the thermal manager 318 when a given thermal state is detected.

In at least some embodiments, the thermal manager 318 implements one or more thermal mitigation mechanisms 130 for performing thermal mitigation operations at the UE device 102 responsive to determining that a given thermal state has been detected. For example, in at least some embodiments, the thermal manager 318 is configured to perform one or more of data rate scheduling based thermal mitigation 202, BWP based thermal mitigation 204, or CQI/MCS based thermal mitigation 206. The thermal manager 318 or another component of the UE 102, in at least some embodiments, is configured to select one or more of these thermal mitigation techniques based on, for example, a temperature of one or more components of the UE device 102, an ambient temperature, heat output of one or more components of the UE device 102, a thermal/throughput cost of each mitigation technique, a thermal/data rate cost of each mitigation technique, manufacturer or carrier design, a combination thereof, and so on.

Example methods 400 to 900 are described with reference to FIG. 4 to FIG. 9 in accordance with one or more aspects of UE device thermal mitigation. It should be understood the present disclosure is not limited to the illustrated sequence of the operations shown in FIG. 4 to FIG. 9. One or more of the operations may be performed in a different order than shown, and multiple operations may be performed in parallel. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local, remote, or local and remote to a computer processing system, and implementations can include software applications, programs, functions, and the like. Alternatively, or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 4 illustrates, in flow chart form, one example method 400 of a UE device 102 implementing data rate scheduling based thermal mitigation, including performing varying levels of thermal mitigation based on the aggregated downlink (DL) throughput per each RAT 108 of the UE device 102. The thermal manager 318, at block 402, determines that a thermal trigger event 401 has occurred. In at least some embodiments, the thermal trigger event 401 indicates a condition or state of the UE device 102 that is addressable by performing one or more thermal mitigation operations. For example, the thermal trigger event 401 occurs when a thermal parameter(s) 403 of the UE device 102 or one or more components of the UE device 102 exceeds a thermal threshold 405, such as a particular temperature or a percentage of a maximum safe operating temperature of the UE device 102 or components. In at least some embodiments, the thermal threshold 405 is a predetermined threshold. The thermal manager 318, in at least some embodiments, detects the thermal trigger event 401 in any of a variety of manners. For example, the thermal manager 318 obtains one or more thermal parameters 403 directly from one or more thermal sensors 308-1, other components of the UE device 102, the CRM 312, or a combination thereof. The thermal manager 318 compares the one or more thermal parameters 403 to at least one thermal threshold 405. The thermal threshold(s) 405, in at least some embodiments, is specified by the manufacturer, a provider of the UE device 102, a user, and so on. If the one or more thermal parameters 403 satisfy the thermal threshold 405, the thermal manager 318 determines the thermal trigger event 401 has occurred. Otherwise, the thermal manager 318 determines that the thermal trigger event 401 has not occurred. In another example, the thermal manager 318 receives an indication 407 from a different component of the UE device 102, indicating that the thermal trigger event 401 has occurred. For example, a different component of the UE device 102 obtains the one or more thermal parameters 403, as described above, and informs the thermal manager 318 when the thermal trigger event 401 has occurred.

The thermal manager 318, at block 404, determines a first data measurement 409 associated with the 4G LTE RAT 108-1 and a second data measurement 411 associated with the 5G NR RAT 108-2 at the UE device 102 for one or more intervals of time. In at least some embodiments, the first data measurement 409 is the aggregated DL throughput on the 4G LTE RAT 108-1 and the second data 411 measurement is the aggregated DL throughput on the 5G NR RAT 108-2. For example, either or both of the thermal manager 318 or a different component of the UE device 102 measures the aggregated DL throughput across the component carriers 413 allocated to the UE device 102 for each RAT 108. In at least some embodiments, the measured aggregated DL throughput is stored in the CRM 312 as part of, for example, the device data 314. The thermal manager 318 accesses the measured aggregated DL throughput to determine the first data measurement 409 for the 4G LTE RAT 108-1 and the second data measurement 411 for the 5G NR RAT 108-2.

The thermal manager 318, at block 406, compares the first data measurement 409 (e.g., aggregated DL throughput) measured for the 4G LTE RAT 108-1 to the second data measurement 411 (e.g., aggregated DL throughput) measured for the 5G NR RAT 108-2. Based on this comparison, the thermal manager 318, at block 408, determines which of the 4G LTE RAT 108-1 and the 5G NR RAT 108-2 has, for example, the higher aggregated DL throughput for the given interval of time. The thermal manager 318, at block 410, selects a first level 415 of thermal mitigation to perform on the RAT 108 with the higher aggregated DL throughput and selects a second level 417 of thermal mitigation to perform on the RAT 108 having the lower aggregated DL throughput.

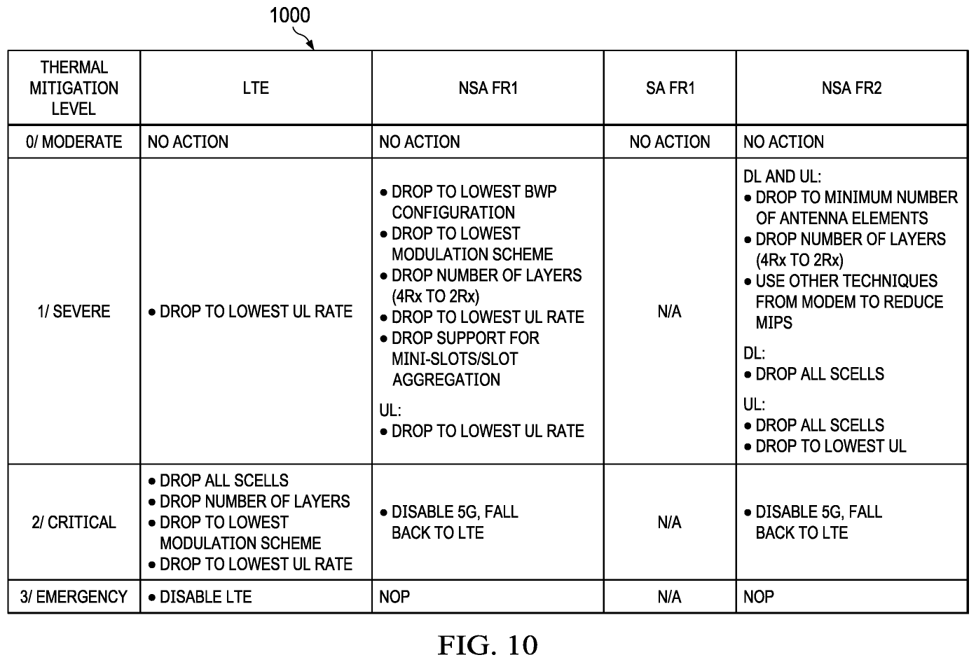

In at least some embodiments, the second level 417 of thermal mitigation is different than the first level 415 of thermal mitigation. The same level of thermal mitigation, in at least some embodiments, comprises different thermal mitigation techniques/actions for different RATs 108. For example, a first level 415 of thermal mitigation for the 4G LTE RAT 108-1, in at least some embodiments, comprises one or more different thermal mitigation actions than the first level 415 of thermal mitigation for the 5G NR RAT 108-2. Also, the first level 415 of thermal mitigation, in at least some embodiments, includes less aggressive thermal mitigation actions that have less performance impact on the associated RAT 108 than the second level 417 of thermal mitigation actions, or vice versa. In these embodiments, the first level 415 of thermal mitigation is a relaxed mitigation level that allows for increased throughput/performance of the associated RAT and more gradual temperature/heat reduction compared to the second level 417 of thermal mitigation, which is an aggressive mitigation level when compared to the first level, or vice versa. However, in other embodiments, the first level 415 of thermal mitigation has an increased reduction in throughput/performance of the associated RAT but increased and or faster temperature/heat reduction than the second level 417 of thermal mitigation. In at least some embodiments, a selected level of thermal mitigation for a given RAT 108 includes performing no thermal mitigation actions for the given RAT 108. FIG. 10 shows a chart 1000 of example thermal mitigation levels and their associated example thermal mitigation actions employed, in at least some embodiments, by the thermal manager 318.

The thermal manager 318, at block 412, performs the selected level of thermal mitigation for each RAT 108. Performing the selected level of thermal mitigation, in at least some embodiments, includes performing one or more thermal mitigation techniques/actions 419 associated with the selected level of thermal mitigation. In at least some embodiments, if the selected level of thermal mitigation comprises multiple mitigations actions 419, the thermal manager 318 performs a single one of the mitigation actions 419 or a combination of the mitigation actions 419.

In an example where the 4G LTE RAT 108-1 is determined to have a higher aggregated DL throughput than the 5G NR RAT 108-2, the selected level (e.g., first level 415) of thermal mitigation for the 4G LTE RAT 108-1 includes, for example, the thermal manager 318 configuring the UE device 102 to drop to the lowest UL data rate for the 4G LTE RAT 108-1 without adjusting the DL data rate. For example, the thermal manager 318, in at least some embodiments, instructs the wireless communication manager 316 to reduce the number of CCs for the UL so that the UL data rate is reduced to the lowest possible data rate. For example, the wireless communication manager 316 adjusts the Buffer Status Report (BSR) sent from the UE device 102 to the first base station 104-1 to indicate that the UE device 102 has less data to transmit than it actually has. The BSR, in at least some embodiments, is periodically/gradually scaled down. In response, the first base station 104-1 reduces the number of uplink (UL) CCs allocated/assigned to the UE device 102. A BSR of 0 (no data to transmit) is transmitted without a gradual scale down in other embodiments. In another example, the thermal manager 318 instructs the wireless communication manager 316 to reduce the transmission power of the UE device 102. The transmission power, in at least some embodiments, is gradually reduced or is directly reduced to a given value.

The selected level (e.g., second level 417) of thermal mitigation for the 5G NR RAT 108-2 includes, for example, the thermal manager 318 configuring the UE device 102 to disable the 5G NR RAT 108-2 for either or both of the FR1 frequency range and the FR2 frequency range and fall back to LTE. For example, the thermal manager 318 or the wireless communication manager 316 disables the 5G NR transceiver 306-2.

In an example where the 5G NR RAT 108-2 is determined to have a higher aggregated DL throughput than the 4G LTE RAT 108-1, the selected level (e.g., first level 415) of thermal mitigation for the 5G NR RAT 108-2 includes, for example, performing one or more thermal mitigation actions 419 for either or both of DL and UL communications. For example, if the UE device 102 is communicating using the NSA FR1 frequency range, one example first level thermal mitigation action includes the thermal manager 318 configuring the UE device 102 to drop to the lowest UL data rate for the 5G NR RAT 108-2, similar to the example described above. Other examples of mitigation actions 419 for the 5G NR RAT 108-2 include the thermal manager 318 configuring the UE device 102 to drop to the lowest BWP configuration, drop to the lowest modulation scheme, drop the number of layers (e.g., 4Rx to 2Rx), drop support for mini-slots/slot aggregation, a combination thereof, and so. In at least some embodiments, configuring the UE device 102 to perform each of these mitigation actions 419 includes the thermal manager 318 informing the wireless communication manager 316 that a specific action is to be performed. The wireless communication manager 316 then makes the appropriate adjustments at the UE device 102, causes one or more communications to be sent to the base station(s) 104 for effectuating the requested change, a combination thereof, and so on. For example, the wireless communication manager 316 causes the UE device 102 to signal the RAN 110 regarding the device's reduced capabilities due to thermals. Various mechanisms and techniques may be implemented by the UE device 102 for signaling reduced capabilities to the RAN 110, such as those described in the 3rd Generation Partnership Project; Technical Specification Group Services and System Aspects; System Architecture for the 5G System (Release 16). As part of this signaling process, the UE device 102, for example, updates the number of BWPs the device can support during the mitigation phase, the maximum MCS supported by the UE device 102, the maximum number of layers supported by the UE device 102, and so on. Upon receiving the message from the UE device regarding reduced capabilities, the RAN 110 schedules downlink resources as per the updated capabilities of the UE device 102.

If the UE device 102 is communicating using the NSA FR2 frequency range, first-level thermal mitigation actions for the UL include, for example, the thermal manager 318 configuring the UE device 102 to drop to the lowest UL data rate for the 5G NR RAT 108-2, dropping all Secondary Cells (Scells), or a combination thereof. An example thermal mitigation action 419 for the DL includes configuring the UE device 102 to drop all Scells. Example thermal mitigation actions for both the UL and DL include configuring the UE device 102 to drop to a minimum number of antenna elements, drop the number of layers (e.g., 4Rx to 2Rx), use other techniques from the 5G NR transceiver 306-2 to reduce MIPS, a combination thereof, and so on. One example of reducing MIPS includes reducing the transmission/receiving capabilities of the UE device 102, which reduces the processing needs or MIPS of the UE device 102.

The selected level (e.g., second level 417) of thermal mitigation for the 4G NR RAT 108-1 also includes performing one or more thermal mitigation actions 419 for either or both of DL and UL communications. For example, thermal mitigation actions 419 for the 4G NR RAT 108-1 include the thermal manager 318 configuring the UE device 102 to drop all Scells, drop the number of layers, drop to the lowest modulation scheme, drop the lowest UL data rate, a combination thereof, and so on.

After the thermal manager 318 has performed one or more mitigation actions 419 for the selected level of thermal mitigation, the thermal manager 318, at block 414, determines if the current thermal state of the UE device 102 is still causing a thermal trigger event 401 to occur. For example, the thermal manager 318 can access current thermal parameters 403 associated with the UE device 102 generated by the thermal sensors 308-1 or obtain information regarding the current thermal state from a different component of the UE device 102. If the thermal trigger event 401 is still occurring, the flow returns to block 410, where the thermal manager 318 selects additional thermal mitigation actions 419 available for the currently selected mitigation level or selects a more aggressive thermal mitigation level (e.g., level 2 instead of level 1). However, if the thermal trigger event 401 is no longer occurring, such as when the current thermal state of the UE device 102 satisfies a given thermal threshold 405, the thermal manager 318 halts the thermal mitigation operations at block 416.

FIG. 5 illustrates, in flow chart form, one example method 500 of a UE device 102 implementing thermal mitigation based on the temperature or amount of heat generated by each RAT. The thermal manager 318, at block 502, determines that a thermal trigger event has occurred similar to block 402 of FIG. 4. The thermal manager 318, at block 504, compares the thermal parameters 403 associated with each RAT 108. The thermal manager 318, at block 506, identifies the RAT 108 with components having the highest temperature or generating the highest amount of heat. In other embodiments, the thermal manager 318 determines the RAT 108 with components having the highest temperature based on the aggregated DL throughput of each RAT 108. For example, a higher throughput or data rate typically results in more heat generated by the components of the RAT 108. Therefore, the RAT 108 having the highest aggregated DL throughput generally has a higher temperature or heat output than the RAT 108 having the lower aggregated DL throughput. The thermal manager 318, in at least some embodiments, identifies the RAT 108 associated with the higher aggregated DL throughput as the RAT generating the most heat or having the highest temperature. In at least some embodiments, the thermal manager 318 further determines whether the UL of a RAT 108 generates more heat than the DL or vice versa. For example, the thermal manager 318 determines if the power amplifier (UL) of a RAT 108 generates more heat than the transceiver 306 (DL), or vice versa.

The thermal manager 318, at block 508, selects a first level of thermal mitigation to perform on the RAT 108 having the highest temperature or highest heat output and selects a second level of thermal mitigation to perform on the RAT 108 having the lowest temperature or lowest heat output. In at least some embodiments, a specific thermal mitigation level, mitigation actions, or a combination thereof is selected by thermal mitigation based on the UL generating more heat than the DL and vice versa. The different levels of thermal mitigation have been described above with respect to block 410 of FIG. 4, and examples of thermal mitigation levels and actions are provided in FIG. 10. The thermal manager 318, at block 510, performs the selected level of thermal mitigation for each RAT 108 as described above with respect to block 412 of FIG. 4.

After the thermal manager 318 has performed one or more mitigation actions for the selected level of thermal mitigation, the thermal manager 318, at block 512, determines if the current thermal state of the UE device 102 is still causing a thermal trigger event to occur as described above with respect to block 414 of FIG. 4. If the thermal trigger event is still occurring, the flow returns to block 508, where the thermal manager 318 selects additional thermal mitigation actions available for the currently selected mitigation level or selects a more aggressive thermal mitigation level (e.g., level 2 instead of level 1). However, if the thermal trigger event is no longer occurring, such as when the current thermal state of the UE device 102 satisfies a given thermal threshold, the thermal manager 318 halts the thermal mitigation operations at block 514.

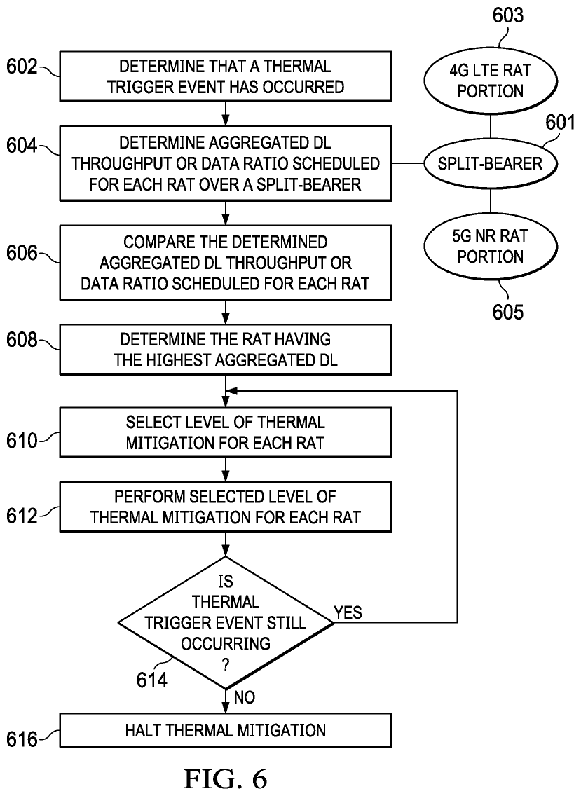

FIG. 6 illustrates, in flow chart form, one example method 600 of a UE device 102 implementing thermal mitigation based on aggregated DL throughput and mitigation strategy in NSA. The thermal manager 318, at block 602, determines that a thermal trigger event has occurred similar to block 402 of FIG. 4. The thermal manager 318, at block 604, determines an aggregated DL throughput or data ratio scheduled for each RAT 108 over a Split-Bearer 601 configured for the UE device 102. For example, either or both of the thermal manager 318 or a different component of the UE device 102 monitors/measures the amount of data received by each RAT 108 during one or more intervals of time over their respective portion of the Split-Bearer 601. The thermal manager 318, at block 606, compares the monitored/measured data amounts. Based on this comparison, the thermal manager 318, at block 608, determines if a higher amount or percentage of data is being received over the 4G LTE portion 603 of the Split-Bearer or the 5G NR portion 605 of the Split-Bearer 601.

The thermal manager 318, at block 612, selects a first level of thermal mitigation to perform on the RAT 108 having the higher amount or percentage of data received/scheduled over the Split-Bearer 601 and selects a second level of thermal mitigation to perform on the RAT 108 having the lower amount or percentage of data received/scheduled over the Split-Bearer 601. The different levels of thermal mitigation have been described above with respect to block 410 of FIG. 4, and examples are provided in FIG. 10. In at least some embodiments, the selected first level of thermal mitigation is an aggressive mitigation level. The selected second level of thermal mitigation is a relaxed mitigation level compared to the first level. Compared to the relaxed mitigation level, the aggressive mitigation level has a greater or steeper impact on reducing the thermals of the associated RAT 108 while also having a greater impact on the performance of the associated RAT 108. Conversely, when compared to the aggressive mitigation level, the relaxed mitigation level has a lesser or shallower impact on reducing the thermals of the associated RAT 108 while having less of an impact on the performance of the associated RAT 108.

In some instances, the RAT 108 having the higher amount/percentage of data received/scheduled over the Split-Bearer 601 experiences a higher operating temperature. As such, the RAT components have less “runway” to cool down before the thermal manager 318 switches these components to supporting only limited cellular service or even emergency shutdown. Therefore, selecting the aggressive mitigation level for the RAT 108 allows for more rapid cooling of the components of the RAT 108 so that limited cellular service or emergency shutdown is avoided. However, in some instances, the temperature associated with the RAT 108 is below a given thermal threshold that, in at least some embodiments, is used to determine whether aggressive or relaxed mitigation is to be selected for the RAT 108. In these embodiments, the relaxed mitigation level is selected for RAT 108 even though RAT 108 has the higher amount/percentage of data received/scheduled over the Split-Bearer 601.

The thermal manager 318, at block 612, performs the selected level of thermal mitigation for each RAT 108 as described above with respect to block 412 of FIG. 4. For example, if an aggressive mitigation level was selected for the 4G LTE RAT 108-2 and a relaxed mitigation level was selected for the 5G NR RAT 108-2, the thermal manager 318 configures the UE device 102 such that one or more of the level 2 actions shown in FIG. 10 under the LTE column is performed for the 4G LTE RAT 108-1 and one or more of the level 1 mitigation actions shown under the NSA FR1 or NSA FR2 column are performed for the 5G NR RAT 108-2. In at least some embodiments, a relaxed mitigation level is associated with one or more timers maintained by the UE device 102. The thermal manager 318 monitors these timers, and upon expiry, the thermal manager 318 adjusts the relaxed mitigation level to an increasingly more aggressive thermal mitigation level if the thermal state of the UE device 102 has not improved beyond or satisfied a given thermal threshold. In at least some embodiments, increasing a relaxed thermal mitigation level to a more aggressive thermal mitigation level includes performing a more aggressive mitigation action or actions.

After the thermal manager 318 has performed one or more mitigation actions for the selected level of thermal mitigation, the thermal manager 318, at block 614, determines if the current thermal state of the UE device 102 is still causing a thermal trigger event to occur as described above with respect to block 414 of FIG. 4. If the thermal trigger event is still occurring, the flow returns to block 608, where the thermal manager 318 selects additional thermal mitigation actions available for the currently selected mitigation level or selects a more aggressive thermal mitigation level (e.g., level 2 instead of level 1). However, if the thermal trigger event is no longer occurring, such as when the current thermal state of the UE device 102 satisfies a given thermal threshold, the thermal manager 318 halts the thermal mitigation operations at block 616.

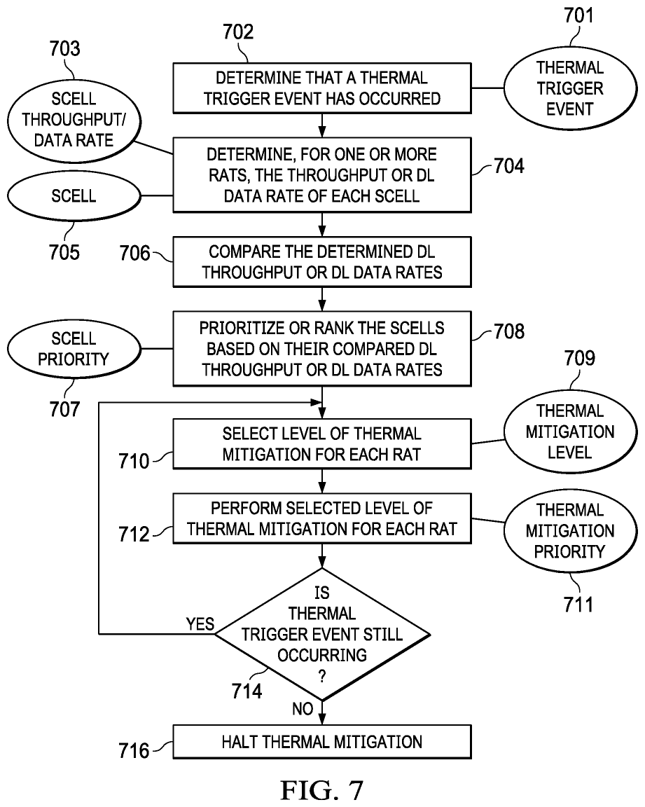

FIG. 7 illustrates, in flow chart form, one example method 700 of a UE device 102 implementing thermal mitigation based on data rate scheduling in a RAT. In this example method, DL thermal mitigation is performed for the 4G LTE RAT 108-1, 5G NR RAT 108-2, or a combination of both based on Scell throughput. The thermal manager 318, at block 702, determines that a thermal trigger event 701 has occurred similar to block 402 of FIG. 4. The thermal manager 318, at block 704, determines, for one or more RATs 108, the throughput/data rate 703 of each Scell 705 connected to the UE device 102. For example, either or both of the thermal manager 318 or a different component of the UE device 102 monitors/measures the amount of data received by a given RAT 108 during one or more time intervals for each Scell 705 connected to the UE device 102. In this example, the throughput/data rate 703 of the Scells 705 is considered since Scells 705 may have varying bandwidths, layers, or modulations. These characteristics of Scells 705 determine the data rate and, therefore, the processing requirements of the UE device 102, all of which contribute to the operating temperature of the UE device 102.

The thermal manager 318, at block 706, compares the determined throughput/data rate amounts 703 of each Scell 705. Based on this comparison, the thermal manager 318, at block 708, prioritizes/ranks the Scells 705 according to their determined throughput/data rate amounts with respect to each other. For example, the thermal manager 318 assigns a priority or rank 707 to each Scell based on their determined throughput/data rate amounts with respect to each other. The highest-ranked Scell is the Scell having the highest throughput/data rate or associated amount of heat generated at the UE device 102. The lowest-ranked Scell is the Scell having the lowest throughput/data rate or associated amount of heat generated at the UE device 102. In other embodiments, thermal manager 318 prioritizes/ranks each Scell 705 according to an amount of heat being generated at the UE device 102 as a function of the throughput/data rate of the Scell 705.

The thermal manager 318, at block 710, selects thermal mitigation level 709, such as a first level of thermal mitigation or a second level of thermal mitigation, to perform on the RAT(s) 108 of interest. In at least some embodiments, the first level of thermal mitigation is a relaxed mitigation level and the second level of thermal mitigation is an aggressive mitigation level. As described above, a relaxed mitigation level, in at least some embodiments, has less negative impact on the performance of the RAT 108 and a more gradual reduction in temperature/heat at the UE device 102. Conversely, an aggressive mitigation level has increased negative impact on the performance of the RAT but a more rapid/steeper reduction in temperature/heat at the UE device 102.

The thermal manager 318, at block 712, performs the selected level of thermal mitigation 709 for the RAT(s) 108. In at least some embodiments, the mitigation actions performed by the thermal manager 318 include configuring the UE device 102 to drop Scells 705 according to a thermal mitigation priority 711 based on their prioritization or ranking. For example, when the selected level of thermal mitigation 709 is an aggressive mitigation level, the thermal manager 318 configures the UE device 102 to drop Scells 705 in order of throughput/data rate or associated amount of heat generated at the UE device 102. In this example, the UE device 102 is configured to start with the highest-ranked Scell 705 since its throughput/data rate causes the most heat to be generated at the UE device 102. Then, the next highest-ranked Scell 705 is dropped if needed, and so on. When the selected level of thermal mitigation 709 is a relaxed mitigation level, the thermal manager 318 configures the UE device to drop Scells 705 in reverse order of throughput/data rate or associated amount of heat generated at the UE device 102. In this example, the UE device 102 is configured to start with the lowest-ranked Scell 705 since its throughput/data rate results in the least amount of heat at the UE device 102. Then, the next lowest-ranked Scell 705 is dropped if needed, and so on.

If thermal mitigation is being performed for both the 4G LTE RAT 108-1 and the 5G NR RAT 108-2, the thermal manager 318, in at least some embodiments, determines whether the 4G LTE Scells 705 or the 5G NR Scells 705 have the higher throughput/data rate or associated heat generation at the UE device 102. The thermal manager 318, in at least some embodiments, then selects the aggressive mitigation level for the RAT 108 having the Scells 705 with the higher throughput/data rate (or heat generation) and selects the relaxed mitigation level for the RAT 108 having the Scells 705 with the lower throughput/data rate or heat generation, or vice versa. The thermal manager 318 then performs mitigation actions for each RAT 108 as described above with respect to block 712.

After the thermal manager 318 has performed one or more mitigation actions for the selected level of thermal mitigation 709, the thermal manager 318, at block 714, determines if the current thermal state of the UE device 102 is still causing a thermal trigger event 701 to occur as described above with respect to block 414 of FIG. 4. In at least some embodiments, the determination made at block 714 is performed after 20) the expiry of at least one timer maintained by the UE device 102. If the thermal trigger event 701 is still occurring, the flow returns to block 708, where the thermal manager 318 selects the next Scell to drop according to the mitigation level or selects a more aggressive thermal mitigation level. However, if the thermal trigger event 701 is no longer occurring, such as when the current thermal state of the UE device 102 satisfies a given thermal threshold, the thermal manager 318 halts the thermal mitigation operations at block 716.

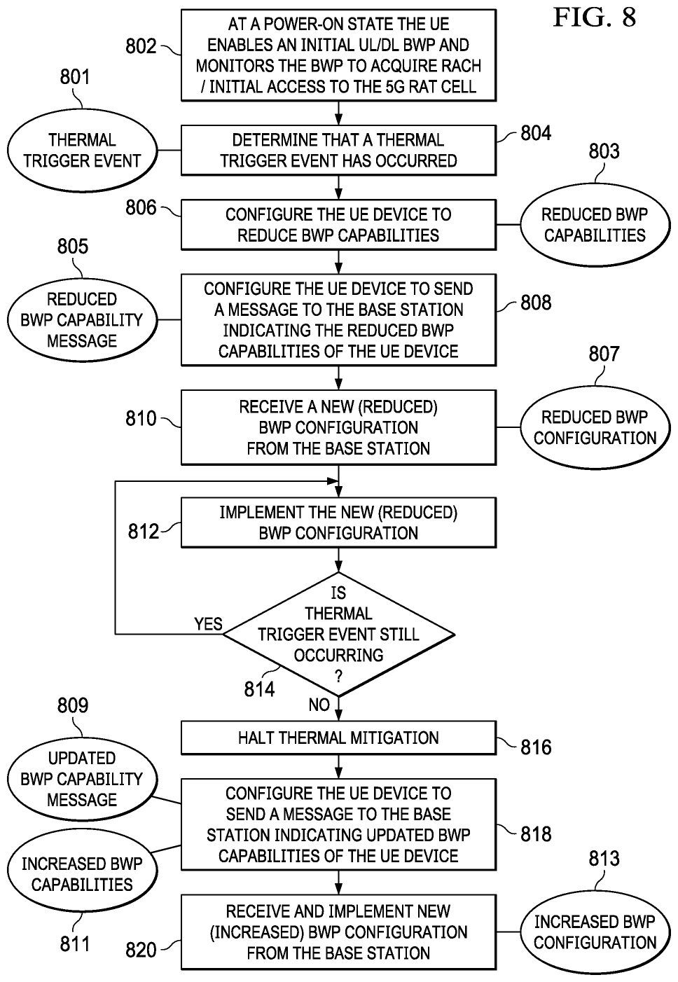

FIG. 8 illustrates, in flow chart form, one example method 800 of a UE device 102 implementing thermal mitigation for a 5G NR RAT 108-2 based on 5G NR bandwidth parts, which are subsets of contiguous common Physical Resource Blocks (PRBs). While in a power-on state, the UE device 102, at block 802, enables an initial UL/DL BWP and monitors the BWP to acquire Random-Access Channel (RACH) for accessing the cell via the base station 104-2. For example, the initial UL/DL BWPs are used for initial access before a Radio Resource Control (RRC) connection is established with the second base station 104-2. During the initial access, the UE device 102 searches for a cell based on a Synchronization Signal Block (SSB). To access the cell, the UE device 102 needs to further read a System Information Block 1 (SIB1) transmitted by the base station 104-2, which carries information including the initial DL/UL BWP configuration. Prior to reading the SIB1, the initial DL BWP of the UE device 102 has the same frequency range and numerology as Control Resource Set (CORESET) 0. However, after reading SIB1, the UE device 102 implements the initial DL/UL BWP configuration identified in the SIB1. This initial DL/UL BWP is used by the UE device 102 to perform a RACH procedure to configure an RRC connection with the base station 104-2. Once the RRC connection has been established, the UE device 102 is configured with a number of DL BWPs and a number of UL BWPs for transmitting/receiving data. The UE device 102 is able to switch between BWPs by activating an inactive BWP and deactivating an active BWP.

The thermal manager 318, at block 804, determines that a thermal trigger event 801 has occurred, similar to block 402 of FIG. 4, and thermal mitigation is initiated. In response, the thermal manager 318, at block 806, configures the UE device 102 (while in a connected state) to reduce its BWP capabilities (reduced BWP capabilities 803). The thermal manager 318, at block 808, configures the UE device 102 to send a message 805 to the base station 104-2, indicating the reduced BWP capabilities 803 of the UE device 102. For example, the wireless communication manager 316 informs the base station 104-2 that the UE device 102 is unable to support multiple BWPs and BWP switching. In response, the UE device 102, at block 810, receives a new/reduced BWP configuration 807 from the base station 104-2. For example, the base station 104-2 configures the UE device 102 with an Active DL/UL BWP similar to the initial UL/DL BWP.

The UE device 102, at block 812, implements the reduced BWP configuration 807 such that UE device 102 only monitors the BWP acknowledged by the base station 104-2 for UL/DL communication. For example, the UE device 102 monitors a subset of the carrier BWP instead of all the BWPs, which results in the UE device 102 cooling down faster. The thermal manager 318, at block 814, determines if the current thermal state of the UE device 102 is still causing a thermal trigger event 801 to occur as described above with respect to block 414 of FIG. 4. If the thermal trigger event is still occurring, the flow returns to block 812. However, if the thermal trigger event 801 is no longer occurring, such as when the current thermal state of the UE device 102 satisfies a given thermal threshold, the thermal manager 318 halts the thermal mitigation operations at block 816. The thermal manager 318, at block 818, configures the wireless communication manager 316 to send a message 809 to the base station 104-2, indicating increased BWP capabilities 811 of the UE device 102. For example, the wireless communication manager 316 informs the base station 104-2 that the UE device 102 supports multiple BWPs and BWP switching. In response, the UE device 102, at block 820, receives and implements a new/increased BWP configuration 813 from the base station 104-2. For example, the base station 104-2 configures the UE device 102 with multiple UL/DL BWPs, and the UE device 102 follows normal BWP operation.

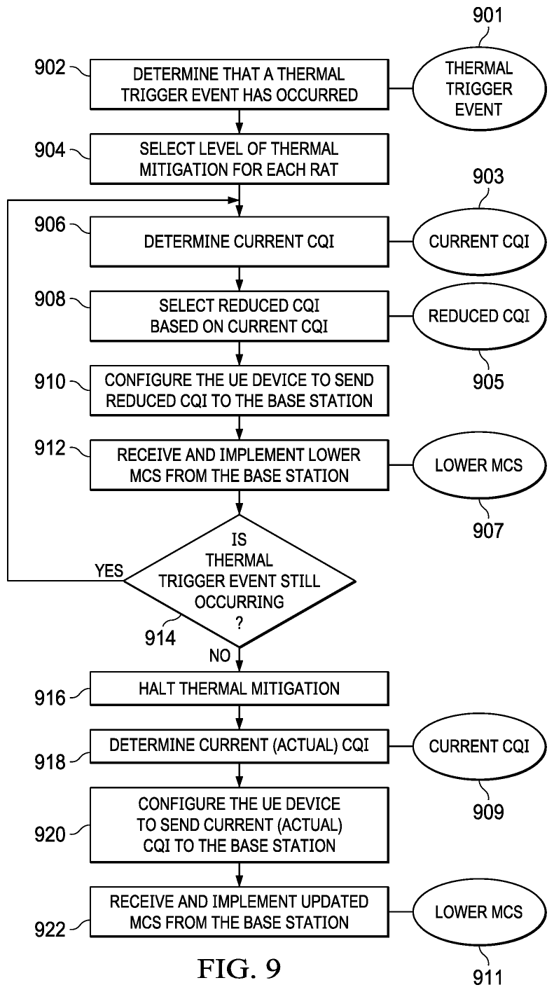

FIG. 9 illustrates, in flow chart form, one example method 900 of a UE device 102 implementing thermal mitigation for one or more of a 4G LTE RAT 108-1 or a 5G NR RAT 108-2 G NR RAT 108-2 based on CQI/MCS. The thermal manager 318, at block 902, determines that a thermal trigger event 901 has occurred similar to block 402 of FIG. 4. In response, the thermal manager 318, at block 904, selects a first level of thermal mitigation, a second level of thermal mitigation, or a combination thereof for either or both of the 4G LTE RAT 108-1 and the 5G NR RAT108-2. In at least some embodiments, the thermal mitigation level(s) is determined based on the operations performed at blocks 406 to 408 of FIG. 4, blocks 504 and 506 of FIG. 5, blocks 604 to 608 of FIG. 6, blocks 704 to 708 of FIG. 7, or a combination thereof. In other embodiments, the thermal mitigation level(s) is determined based on one or more other mechanisms. In at least some embodiments, a level of thermal mitigation is not selected and the process flows from block 902 directly to block 906.

The thermal manager 318, at block 906, determines the current CQI 903 for the UE device 102. A CQI indicates the highest MCS and code rate at which the block error rate (BLER) of the channel does not exceed a given amount (e.g., 10%). The UE device 102 typically uses the Signal-to-Interference-plus-Noise Ratio (SINR) to determine the CQI. SINR is the ratio of the received signal level and the sum of interference and noise. The CQI is expressed as a data rate that the UE device 102 can support under the current radio conditions. CQI is typically expressed as one of fifteen (15) codes, with a CQI of 0 indicating the poorest channel quality and a CQI of 15 indicates the best channel quality.

Based on the CQI reported by the UE device 102, the base station 104 allocates the MCS. A higher CQI results in a higher MCS being allocated. A higher MCS typically results in a higher clock rate at the UE device 102 for managing the higher data rates associated with the higher MCS. As such, a higher MCS results in increased heat generation and temperature at the UE device 102. Therefore, the temperature/heat at the UE device 102, in at least some embodiments, is mitigated by stepping down the current CQI of the UE device 102 to receive a lower MCS. For example, the thermal manager 318, at block 908, selects a CQI 905 to report to the base station 104 that is lower than the current CQI. In one example, if the actual CQI 903 is in a range of 12 to 15, a reduced CQI 905 of 11 is selected. If the actual CQI 903 is in a range of 7 to 11, a reduced CQI 905 of 6 is selected. If the actual CQI 903 is in a range of 4 to 6, a reduced CQI 905 of 3 is selected. It should be understood that other mechanisms for determining the lower CQI are applicable as well. Lowering the CQI results in a lower MCS, which reduces the clock speed and data rates, thereby cooling the UE device 102. The scaling down of the CQI/MCS is advantageous because it allows the UE device 102 to remain connected to the base station 104 in contrast to mitigation mechanisms that immediately send a CQI of 0 even if the UE device has an actual CQI of, for example, 15.

The thermal manager, at block 910, configures the UE device 102 to send the reduced/lower CQI 905 to the base station 104. For example, the wireless communication manager 316 sends the reduced CQI 905 to the base station 104 via the Physical Uplink Control Channel (PUCCH) or the Physical Uplink Shared Channel (PUSCH). In response, the UE device 102, at block 912, receives and implements a lower MCS 907 from the base station 104. The thermal manager 318, at block 914, determines if the current thermal state of the UE device 102 is still causing a thermal trigger event 901 to occur as described above with respect to block 414 of FIG. 4. This determination, in at least some embodiments, is made after the expiry of a timer. If the thermal trigger event 901 is still occurring, the flow returns to block 906. However, if the thermal trigger event 901 is no longer occurring, such as when the current thermal state of the UE device 102 satisfies a given thermal threshold, the thermal manager 318 halts the thermal mitigation operations at block 916. The thermal manager 318 or a different component, at block 918, determines the current (actual) CQI 909 of the UE device 102. The thermal manager, at block 920, configures the UE device 102 to send its actual CQI 909 to the base station 104. The UE device 102, at block 922, receives and implements an updated MCS 911 from the base station 104. This MCS 911, in at least some embodiments, is higher than the MCS 907 received during thermal mitigation.

One or more embodiments offer technical effects and benefits in terms of mitigating performance issues that result from, for example, increased operating temperatures of devices, such as the UE device 102, or components thereof. Increased operating temperatures, in some instances, thermally limit the performance of the UE device, which degrades throughput, damages physical components of the UE device 102, or causes discomfort to a user. Various mitigation methods and systems are described herein.

One or more of the operations described herein, in at least some embodiments, are implemented using one or more computer programs, for example embodied as a computer program product comprising a set of instructions which, when executed on an apparatus such as the UE device 102, is configured to cause the apparatus to carry out the operations described herein. Similarly, in at least some embodiments, there is be provided a non-transitory computer readable medium comprising program instructions stored thereon for performing the operations described herein.

In some embodiments, certain aspects of the techniques described above are implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium can be in source code, assembly language code, object code, or another instruction format that is interpreted or otherwise executable by one or more processors.

A computer-readable storage medium includes any storage medium or combination of storage media accessible by a computer system during use to provide instructions and/or data to the computer system. Such storage media can include, but is not limited to, optical media (e.g., compact disc (CD), digital versatile disc (DVD), Blu-ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any features that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method at a cellular user equipment (UE) device, the method comprising:
responsive to a thermal trigger event having occurred, determining a first data measurement associated with at least a first radio access technology (RAT) of the UE device and a second data measurement associated with at least a second RAT of the UE device; and
performing a first level of thermal mitigation for the first RAT and a second level of thermal mitigation for the second RAT based on the first data measurement being different than the second data measurement.

2. The method of claim 1, wherein determining that the thermal trigger event has occurred comprises determining that one or more thermal parameters associated with the UE device satisfies at least one thermal threshold.

3. The method of claim 1, wherein the first data measurement is a first data throughput determined based on monitoring an aggregated data throughput across multiple downlink component carriers associated with the first RAT, and wherein the second data measurement is a second data throughput determined based on monitoring an aggregated throughput rate across multiple downlink component carriers associated with the second RAT.

4. The method of claim 1, wherein the first data measurement is a first amount of data scheduled for a first portion of a Split-Bearer configured for the first RAT, and wherein the second data measurement is a second amount of data scheduled for a second portion of the Split-Bearer configured for the second RAT.

5. (canceled)

6. (canceled)

7. The method of claim 1, further comprising:
responsive to performing the first level of thermal mitigation and the second level of thermal mitigation, determining if the thermal trigger event has ended;
responsive to the thermal trigger event having ended, halting the first level of thermal mitigation and the second level of thermal mitigation; and
responsive to the thermal trigger event still occurring, increasing at least one of the first level of thermal mitigation or the second level of thermal mitigation to a more aggressive level of thermal mitigation.

8. The method of claim 1, further comprising:
selecting the first level of thermal mitigation based on the first level of thermal mitigation being a relaxed level of thermal mitigation; and
selecting the second level of thermal mitigation based on the second level of thermal mitigation being an aggressive level of thermal mitigation,
wherein the relaxed level of thermal mitigation reduces a temperature of the UE device more gradually than the aggressive level of thermal mitigation and has a less negative impact on data throughput than the aggressive level of thermal mitigation.

9. The method of claim 8, wherein the first level of thermal mitigation is further selected based on the first data measurement being lower than the second data measurement, and wherein the second level of thermal mitigation is further selected based on the second data measurement being higher than the first data measurement.

10. The method of claim 1, further comprising:
selecting the first level of thermal mitigation based on the first level of thermal mitigation being an aggressive level of thermal mitigation; and
selecting the second level of thermal mitigation based on the second level of thermal mitigation being a relaxed level of thermal mitigation,
wherein the aggressive level of thermal mitigation reduces a temperature of the UE device faster than the relaxed level of thermal mitigation and has an increased negative impact on data throughput than the relaxed level of thermal mitigation.

11. (canceled)

12. (canceled)

13. A method at a cellular user equipment (UE) device, the method comprising:
determining that a thermal trigger event has occurred;
responsive to the thermal trigger event, determining a data measurement associated with each of a plurality of secondary cells associated with at least a one radio access technology (RAT) of the UE device; and
selecting a level of thermal mitigation for the at least one RAT based on the data measurement; and
performing the selected level of thermal mitigation.

14. The method of claim 13, further comprising:
determining a thermal mitigation priority for each of the plurality of secondary cells based on their associated data measurement.

15. The method of claim 14, wherein performing the selected level of thermal mitigation comprises:
selecting at least one secondary cell from the plurality of secondary cells based on the thermal mitigation priority determined for the at least one secondary cell; and
dropping the selected secondary cell.

16. A method at a cellular user equipment (UE) device within a cellular network, the method comprising:
responsive to a thermal trigger event having occurred, informing the cellular network of reduced bandwidth part capabilities at the UE device;
receiving a reduced bandwidth part configuration from the cellular network; and
implementing the reduced bandwidth part configuration.

17. The method of claim 16, further comprising:
determining that the thermal trigger event has ended;
responsive to the thermal trigger event having ended, informing the cellular network of increased bandwidth part capabilities at the UE device;
receiving an increased bandwidth part configuration from the cellular network; and
implementing the increased bandwidth part configuration.

18. The method of claim 13, further comprising:
responsive to the thermal trigger event having occurred, determining a current channel quality indicator for a connection with the cellular network;
selecting a lower channel quality indicator based on the current channel quality indicator; and
sending the lower channel quality indicator to the cellular network.

19. The method of claim 18, further comprising:
determining that the thermal trigger event has ended;
responsive to the thermal trigger event having ended, determining a new current channel quality indicator for the connection with the cellular network; and
sending the new current channel quality indicator to the cellular network.

20. A user equipment device, comprising:
one or more radio frequency (RF) modems configured to wirelessly communicate with at least one network;
one or more processors coupled to the one or more RF modems; and
at least one memory storing executable instructions, the executable instructions configured to manipulate at least one of the one or more processors or the one or more RF modems to:
responsive to a thermal trigger event having occurred, determine a first data measurement associated with at least a first radio access technology (RAT) of the UE device and a second data measurement associated with at least a second RAT of the UE device; and
perform a first level of thermal mitigation for the first RAT and a second level of thermal mitigation for the second RAT based on the first data measurement being different than the second data measurement.

21. The UE of claim 20, wherein the executable instructions are configured to manipulate at least one of the one or more processors or the one or more RF modems to determine that the thermal trigger event has occurred by determining that one or more thermal parameters associated with the UE device satisfies at least one thermal threshold.

22. The UE of claim 20, wherein:
the first data measurement is a first data throughput determined based on monitoring an aggregated data throughput across multiple downlink component carriers associated with the first RAT, and wherein the second data measurement is a second data throughput determined based on monitoring an aggregated throughput rate across multiple downlink component carriers associated with the second RAT; or
the first data measurement is a first amount of data scheduled for a first portion of a Split-Bearer configured for the first RAT, and wherein the second data measurement is a second amount of data scheduled for a second portion of the Split-Bearer configured for the second RAT.

23. The UE of claim 20, wherein the executable instructions are further configured to manipulate at least one of the one or more processors or the one or more RF modems to:
responsive to performing the first level of thermal mitigation and the second level of thermal mitigation, determine if the thermal trigger event has ended;
responsive to the thermal trigger event having ended, halt the first level of thermal mitigation and the second level of thermal mitigation; and
responsive to the thermal trigger event still occurring, increase at least one of the first level of thermal mitigation or the second level of thermal mitigation to a more aggressive level of thermal mitigation.

24. The UE of claim 20, wherein the executable instructions are further configured to manipulate at least one of the one or more processors or the one or more RF modems to:
select the first level of thermal mitigation based on the first level of thermal mitigation being a relaxed level of thermal mitigation; and
select the second level of thermal mitigation based on the second level of thermal mitigation being an aggressive level of thermal mitigation,
wherein the relaxed level of thermal mitigation reduces a temperature of the UE device more gradually than the aggressive level of thermal mitigation and has a less negative impact on data throughput than the aggressive level of thermal mitigation.

25. The UE of claim 24, wherein the first level of thermal mitigation is further selected based on the first data measurement being lower than the second data measurement, and wherein the second level of thermal mitigation is further selected based on the second data measurement being higher than the first data measurement.
